(19) United States
(12) Patent Application Publication
(10) Pub. No.: US 2009/0260442 A1
(43) Pub. Date: Oct. 22, 2009

(54) Drum Inspecting Apparatus

(76) Inventor: Toru Hara, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/885,853

(22) PCT Filed: Jul. 19, 2007
(86) PCT No.: PCT/JP2007/064281

§ 371 Date: Sep. 6, 2007

(30) Foreign Application Priority Data
Jul. 19, 2007 (JP) 2007-187834

(51) Int. Cl. G01B 17/02

(52) U.S. Cl. 73/627

(57) ABSTRACT

Inspecting a loss in section such as corrosion, rust and abrasion due to physical factor generated in an inside face of a drum securely and rapidly with a simple structure and specifying a generation position thereof.

A drum inspecting apparatus for inspecting a loss in section generated in an inside face of a drum 1 from an outer face side, comprising an inspection ultrasonic wave device for inspection by detecting a position having a reduced thickness generated in the inside face of the drum 1 and estimating a range thereof with lateral ultrasonic wave, wherein the inspection ultrasonic wave device has a plurality of ultrasonic probes 2a for generating ultrasonic wave for the inspection of a side plate of the drum 1, attached to a top plate circumferential outer edge portion 11a or a bottom plate circumferential outer edge portion 12a of the drum 1.

### TECHNICAL FIELD

The present invention relates to a drum inspecting apparatus for inspecting a drum for any defect.

### BACKGROUND ART

In recent years, dripping has been recognized in part of drums accommodating low level nuclear waste or the like and the dripping is considered to be caused from reduction of the section due to rust. According to an inspection method for a defect in the drum, a supporting rod in which an illumination light and a plurality of CCD cameras are disposed is mounted to a supporting body disposed in the vicinity of a drum transportation line such that it can be lifted up/down freely. The CCD camera of this supporting rod is inserted into the drum so as to photograph each photographing object area in the drum with each camera at a predetermined position in the vertical direction and this photographed image is held in a memory temporarily. Then, the image in the memory is replayed on a monitor, and a replayed still image is observed with the naked eye so as to determine any defect in the photographing object area (patent document 1).

Patent document 1: Japanese Patent Application Laid-Open No. 9-288067

### DISCLOSURE OF THE INVENTION

### Problem to be Solved by the Invention

The above invention aims at detecting a defect by photographing each photographing object area in a drum and cannot be used for detection of any defect in a sealed drum accommodating low level nuclear waste. Accordingly, the inventor has developed a basic technology for measuring for presence/absence of any defect and a plate thickness using ultrasonic wave, and however the sealed drum accommodating low level nuclear waste needs to be inspected securely and rapidly with a simple structure as regards its side plate, top plate and bottom plate.

By considering such a current condition, the present invention intends to provide a drum inspecting apparatus which can detect corrosion, rust and abrasion due to physical factor, generated in an inside face of a drum securely and rapidly with a simple structure and can specify its generation position.

### Means for Solving the Problem

The present invention is configured as follows in order to solve the above-described problem and achieve the object.

The invention described in claim 1 exists in a drum inspecting apparatus for inspecting a loss in section generated in an inside face of a drum from an outer face side, comprising an inspection ultrasonic wave device for inspection by detecting a position having a reduced thickness generated in the inside face of the drum and estimating a range thereof with lateral ultrasonic wave, wherein the inspection ultrasonic wave device has a plurality of ultrasonic probes for generating ultrasonic wave for the inspection of a side plate of the drum, attached to a top plate circumferential outer edge portion or a bottom plate circumferential outer edge.portion of the drum.

The invention described in claim 2 exists in a drum inspecting apparatus for inspecting a loss in section generated in an inside face of a drum from an outer face side, comprising an inspection ultrasonic wave device for inspection by detecting a position having a reduced thickness generated in the inside face of the drum and estimating a range thereof with lateral ultrasonic wave, wherein the inspection ultrasonic wave device has a plurality of ultrasonic probes for generating ultrasonic wave for the inspection of a top plate or a bottom plate of the drum, attached to a top plate circumferential outer edge portion or a bottom plate circumferential outer edge portion of the drum.

The invention described in claim 3 exists in a drum inspecting apparatus for inspecting a loss in section generated in the inside face of a drum accommodating low level nuclear waste from an outer face side, comprising an inspection ultrasonic wave device for inspection by detecting a position having a reduced thickness generated in the inside face of the drum and estimating a range thereof with lateral ultrasonic wave, wherein the inspection ultrasonic wave device has a plurality of ultrasonic probes for generating ultrasonic wave for the inspection of the side plate of the drum attached to the top plate circumferential outer edge portion or bottom plate circumferential outer edge portion of the drum and a plurality of ultrasonic probes for generating ultrasonic wave for the inspection of a top plate or a bottom plate of the drum attached to the top plate circumferential outer edge portion or bottom plate circumferential outer edge portion of the drum.

The invention described in claim 4 exists in the drum inspecting apparatus according to claim 1 or 3 wherein a detachable supporting frame is attached to the top plate circumferential outer edge portion or the bottom plate circumferential outer edge portion and the supporting frame is provided with a plurality of ultrasonic probes for generating ultrasonic wave for the inspection of the side plate.

The invention described in claim 5 exists in the drum inspecting apparatus according to claim 2 or 3 wherein a detachable supporting frame is attached to the top plate circumferential outer edge portion or the bottom plate circumferential outer edge portion and the supporting frame is provided with a plurality of ultrasonic probes for generating ultrasonic wave for the inspection of the top plate or the bottom plate.

The invention described in claim 6 exists in the drum inspecting apparatus according to claim 1 or 3 wherein a detachable supporting frame is attached to the top plate circumferential outer edge portion or the bottom plate circumferential outer edge portion and the supporting frame is provided with a plurality of ultrasonic probes for generating ultrasonic wave for the inspection of the side plate and a plurality of ultrasonic probes for generating ultrasonic waves for the inspection of the top plate or the bottom plate.

The invention described in claim 7 exists in the drum inspecting apparatus according to any one of claims 1 to 6 wherein the ultrasonic probe is accommodated in an inner case an end of which is open, and the inner case is disposed movably within an outer case an end of which is open, the outer case being attached to the supporting frame and provided with a sticking magnet which is to be stuck to the drum, and an urging means for urging the ultrasonic probe in a direction to the drum being equipped between the outer case and the inner case.

The invention described in claim 8 exists in the drum inspecting apparatus according to any one of claims 1 to 7 wherein both faces of iron plate of the drum are galvanized and the galvanized surface is coated with resin film.

The invention described in claim 9 exists in the drum inspecting apparatus according to any one of claims 1 to 8 wherein the inspection is carried out by propagating the lateral ultrasonic wave from a top end portion to a bottom end portion of the side plate of the drum and from the bottom end portion to the top end portion.

The invention described in claim 10 exists in the drum inspecting apparatus according to any one of claims 1 to 8 wherein the inspection is carried out by propagating the lateral ultrasonic wave from the circumferential outer edge portion of the top plate or bottom plate of the drum toward a central portion.

### EFFECT OF THE INVENTION

With the above-described structure, the present invention exerts following effects.

According to the invention described in claim 1, by performing inspection for detecting a portion having a reduced thickness generated in the inside face of the drum and estimating its range with lateral ultrasonic wave, for example, a loss in section generated in the inside face of the drum accommodating low level nuclear waste can be detected and its generation position can be specified. Further, because the inspection ultrasonic wave device inspects the side plate of the drum by attaching a plurality of ultrasonic probes on the top plate circumferential outer edge or bottom plate circumferential outer edge of the drum and generating ultrasonic wave with the plurality of the ultrasonic probes, a loss in section such as corrosion, rust and abrasion due to physical factor generated in the inside face of the side plate of the drum can be detected securely and rapidly with a simple structure and its generation position can be specified.

According to the invention described in claim 2, by performing inspection for detecting a portion having a reduced thickness generated in the inside face of the drum and estimating its range with lateral ultrasonic wave, for example, a loss in section generated in the inside face of the drum accommodating low level nuclear waste can be detected and its generation position can be specified. Further, because the inspection ultrasonic wave device inspects the top plate or bottom plate of the drum by attaching a plurality of ultrasonic probes on the top plate circumferential outer edge or bottom plate circumferential outer edge of the drum and generating ultrasonic wave with the plurality of the ultrasonic probes, a loss in section such as corrosion, rust and abrasion due to physical factor generated in the inside face of the top plate or bottom plate of the drum can be detected securely and rapidly with a simple structure and its generation position can be specified.

According to the invention described in claim 3, by performing inspection for detecting a portion having a reduced thickness generated in the inside face of the drum and estimating its range with lateral ultrasonic wave, for example, a loss in section generated in the inside face of the drum accommodating low level nuclear waste can be detected and its generation position can be specified. Further, because the inspection ultrasonic wave device inspects the side plate of the drum by attaching a plurality of ultrasonic probes on the top plate circumferential outer edge or bottom plate circumferential outer edge of the drum and generating ultrasonic wave with the plurality of the ultrasonic probes and further the top plate or bottom plate of the drum by attaching a plurality of ultrasonic probes on the top plate circumferential outer edge or bottom plate circumferential outer edge of the drum and generating ultrasonic wave with the plurality of the ultrasonic probes, a loss in section such as corrosion, rust and abrasion due to physical factor generated in the inside face of the top plate or bottom plate of the drum can be detected securely and rapidly with a simple structure and its generation position can be specified.

According to the invention described in claim 4, by attaching a plurality of the ultrasonic probes for generating ultrasonic wave for inspection of the side plate to the supporting frame attached to the top plate circumferential outer edge portion or the bottom plate circumferential outer edge portion and generating ultrasonic wave with the plurality of the ultrasonic probes, a loss in section such as corrosion, rust and abrasion due to physical factor generated in the inside face of the side plate of the drum can be detected securely and rapidly with a simple structure and its generation positions can be specified.

According to the invention described in claim 5, by attaching a plurality of the ultrasonic probes for generating ultrasonic wave for inspection of the top plate or bottom plate to the supporting frame attached to the top plate circumferential outer edge portion or the bottom plate circumferential outer edge portion and generating ultrasonic wave with the plurality of the ultrasonic probes, a loss in section such as corrosion, rust and abrasion due to physical factor generated in the inside face of the top plate or the bottom plate of the drum can be detected securely and rapidly with a simple structure and its generation positions can be specified.

According to the invention described in claim 6, by attaching a plurality of the ultrasonic probes for generating ultrasonic wave for inspection of the side plate to the supporting frame attached to the top plate circumferential outer edge portion or the bottom plate circumferential outer edge portion and a plurality of the ultrasonic probes for generating ultrasonic waves for inspection of the top plate or bottom plate and then, generating ultrasonic wave with the plurality of the ultrasonic probes, a loss in section such as corrosion, rust and abrasion due to physical factor generated in the inside face of the side plate, the top plate or the bottom plate of the drum can be detected securely and rapidly with a simple structure and its generation positions can be specified.

According to the invention described in claim 7, by sticking the outer cases attached to the supporting frame to the drum with sticking magnets while urging the ultrasonic probes in the direction to the drum and generating ultrasonic wave with the ultrasonic probes, a loss in section such as corrosion, rust and abrasion due to physical factor can be detected securely and rapidly with a simple structure and its generation position can be specified.

According to the invention described in claim 8, the drum is constructed by galvanizing both faces of an iron plate and coating the galvanized surface with resin. Consequently, a loss in section due to rust generated in the inside face of the drum accommodating low level nuclear waste can be detected from an outer face side.

According to the invention described in claim 9, the entire range of the side plate of the drum can be inspected at a high accuracy by propagating lateral ultrasonic wave from the top end portion to the bottom end portion and from the bottom end portion to the top end portion of the drum.

According to the invention described in claim 10, the entire range of the top plate and the bottom plate of the drum can be inspected at a high accuracy by propagating lateral ultrasonic wave from the circumferential outer edge portion of the top plate or the bottom plate of the drum toward the central portion.

### BEST MODE FOR CARRYING OUT THE INVENTION

Hereinafter, the embodiment of the drum inspecting apparatus of the present invention will be described. The embodiment of the present invention indicates the best mode of the invention and the present invention is not restricted to this one.

### [Inspection Object]

First, the inspection object will be described with reference to FIGS. 1 and 2. FIG. 1 is a side view of the drum and FIG. 2 is a sectional view of part of the drum.

The drum 1 of this embodiment accommodates low level nuclear waste. This drum 1 comprises a side plate 10, a top plate 11 and a bottom plate 12 and as shown in FIG. 2, both faces of an iron plate 1a are treated with zinc plating 1b and the surface of this zinc plating is coated with resin film 1c. For example, the thickness of the iron plate 1a is 1.6 mm, the thickness of the zinc plating 1b is 0.02 mm and the thickness of the resin film 1c is 0.03 mm. Although the resin film 1c is formed of for example, epoxy resin, it is not restricted to the epoxy resin. Further, the drum 1 may be prepared by only painting the iron plate 1a and the structure of the drum is not restricted to any particular one.

In the drum 1 which accommodates low level nuclear waste, sometimes loss of its section occurs due to rust or abrasion originating from physical reason and the loss of the section generated by such a reason is detected from an outside face. A drum inspection method and apparatus will be described below.

### [First Inspection]

The first inspection will be described based on FIGS. 3 to 8. FIG. 3 is a diagram showing wave style of SV wave, FIG. 4 is a diagram showing the wave shape of SH wave, FIG. 5 is a diagram showing a condition of detecting from a top portion to a bottom portion of the drum, FIG. 6 is a diagram showing a condition of detecting from a bottom portion to a top portion of the drum, FIG. 7 is a diagram showing a drill hole in the top plate and bottom plate and FIG. 8 is a diagram showing a condition of inspecting the top plate and bottom plate.

In the first inspection, any portion whose thickness is reduced, generated in an inner face of the drum 1 is detected and its range is estimated with lateral wave ultrasonic sound using a first inspection device 2. The first inspection can inspect an entire range of a side plate 10 of the drum 1 at a high precision by propagating the lateral ultrasonic wave from the top end portion to the bottom end portion of the side plate 10 of the drum 1 and from the bottom end portion to the top end portion. Further, the first inspection can also inspect the entire range of the top plate 11 and the bottom plate 12 of the drum 1 by propagating lateral ultrasonic wave from circumference outer edge portion of the top plate 11 and the bottom plate 12 to a central portion.

### [First Inspection Ultrasonic Device]

The first inspection ultrasonic device 2 comprises a ultrasonic probe 2a and a ultrasonic flaw detector 2b. The ultrasonic probe 2a uses a lateral wave oscillator 2a1 and this lateral wave oscillator 2a1 is an oscillator which oscillates by sliding corresponding to an excitation voltage so as to generate the lateral wave from the beginning. The lateral wave has a directivity because it is a wave which oscillates in a direction perpendicular to the propagation direction. The lateral wave emitted from an ordinary angel probe is called SV wave because it oscillates in a direction perpendicular to a flaw detection surface as shown in FIG. 3. The lateral wave which oscillates in a parallel direction to the flaw detection surface or a considered surface is called SH wave. The SH wave can emit a lateral wave in a direction near a refraction angle of 90° strongly different from the SV wave as shown in FIG. 4.

The present invention applies the SH wave considering that the thickness of the drum 1 which is an object is small and the ultrasonic wave is propagated over a certain extent of distance.

The ultrasonic flaw detector 2b has a transmitting portion 2b1 and a receiving portion 2b2. The transmitting portion 2b1 drives the ultrasonic probe 2a and data obtained by driving this ultrasonic probe 2a is displayed on the receiving portion 2b2.

### [Contact Medium]

The lateral wave (SV wave) oscillates the longitudinal wave from the lateral wave oscillator 2a1 so as to generate waves of each mode by changing the incident angle to the drum 1. Thus, the longitudinal wave transmitted from the lateral wave oscillator 2a1 can be entered into steel material of the drum 1 easily through liquid such as water, oil, glycerine.

On the other hand, because according to the SH wave, the lateral wave which is generated by the lateral wave oscillator 2a1, oscillating laterally is entered into the steel material just as the lateral wave, the lateral wave, which is not propagated in liquid, cannot be entered into the steel material in the same contact medium as for the longitudinal wave. Then, a dedicated contact medium for the lateral wave, having some extent of viscosity was used.

### EXAMPLE

### (Inspection Device)

UI-23Lf low frequency type ultrasonic flaw detector manufactured by SHORYO ELECTRONICS CORPORATION was used as the ultrasonic flaw detector 26 and 0.5C20HA90 ultrasonic flaw detector manufactured by KABUSHIKI KAISHA KENSA GIJUTSU KENKYUJO was used as the ultrasonic flaw detector.

### (Side Plate Inspection Method)

As shown in FIG. 5, the ultrasonic probe 2a was moved on the top end portion of the side plate 10 of the drum 1 for example at an interval of 40 mm and any flaw in the drill hole generated in the side plate 10 of the drum 1 was detected from the top to the bottom. As shown in FIG. 6, the ultrasonic probe 2a was moved on the bottom end portion of the side plate 10 of the drum 1 at an interval of 40 mm and any flaw in the drill hole generated in the side plate 10 of the drum 1 was detected from the bottom to the top.

Drill holes were processed at nine positions in a range of 0.48 mm-0.70 mm in depth from the inside face and in a range of 3.34-4.07 mm in diameter such that they are distributed in the height direction of the side plate 10 and named S1-S9 from the bottom end portion (bottom plate side). Nine sidelines on extensions in the height direction of the drill holes S1-S9 were measured and as for the measuring direction, measurements were implemented in two directions, from the top (top plate side) to the bottom (bottom plate side) and from the bottom to the top. The ultrasonic probe 2a was fixed using a holder in which a magnet was incorporated in a top end portion and a bottom end portion thereof.

### (Side Plate Inspection Result)

In the measurement, reflection echo height when the SH wave was entered and propagated from the top and bottom of the side plate toward drill holes S1-S9 was adjusted to 80% the height of a display portion of the ultrasonic flaw detector 2b. The reflection echo from the drill holes S1-S9 aiming at detection as shown in flaw detecting shapes could be confirmed clearly on all measuring lines, as shown in FIGS. 5, 6. A reflection echo from the drill hole on other measuring line was detected on a measuring line. For example, in measurement from the top of the side line 7), it could be confirmed from the flaw detecting shapes that the drill holes S1-S8 were detected. Consequently, by using expansion of this beam, a flaw detecting area (range) by the primary measurement can be set up whereby providing a factor which determines a flaw detecting method for the side plate.

### (Inspection Method of Bottom Plate and Top Plate)

As for the top plate 11 and bottom plate 12, an extent of detection of the drill holes processed in the top plate 11 and bottom plate 12 was confirmed using the ultrasonic probe 2a for the SH wave like for the side plate 10. The drill holes were processed at nine positions in a range of 0.30 to 0.64 mm in depth from the inside surface and in a range of 2.65 mm to 3.83 mm in diameter such that they are distributed spirally in the radius direction as shown in FIG. 7 and named B1-B9 from the central portion. Eight side lines on a line divided by 8 equally in the circumferential direction were measured and as for the measuring direction, the measurement was carried out from the circumferential outer edge of the top plate and bottom plate toward the central portion thereof. The ultrasonic probe 2a was fixed on the circumferential outer edge of the top plate and bottom plate using a holder incorporating a magnet.

### (Inspection Result of Bottom Plate and Top Plate)

The measurement was carried out by adjusting the reflection echo height when the SH wave was entered and propagated from the circumferential outer edge portion of the top plate and bottom plate toward the central portion to 80% the height of the display portion of the ultrasonic flaw detector 2b. The reflection echoes from drill holes which are an object for detection as shown in the flaw detecting shapes of FIG. 8 could be confirmed clearly on all the measuring lines.

### [Structure of Primary Inspection Ultrasonic Wave Device]

The primary inspection ultrasonic wave device 2 performs primary inspection of detecting for a reduced thickness portion generated in the inside face of the drum 1 and estimating its range using lateral ultrasonic wave. A schematic structure of this primary inspection ultrasonic wave device 2 will be described in FIGS. 9 to 16.

The embodiment shown in FIGS. 9 to 13 will be described. FIG. 9 is a plan view showing a condition in which ultrasonic probes of the primary inspection ultrasonic wave device are attached to a drum. FIG. 10 is a side view showing a condition in which the ultrasonic probe of the primary inspection ultrasonic device is attached to the drum. FIG. 11 is a plan view showing an attachment condition of the ultrasonic probe. FIG. 12 is a side view showing the attachment condition of the ultrasonic probe. FIG. 13 is a sectional view showing the attachment condition of the ultrasonic probe.

A supporting frame 50 is attached detachably to a top plate circumferential outer edge portion 11a of the drum 1 and a pair of semi-circular division arms 50a, 50b are connected with a supporting shaft 50c such that they can be opened/closed and then, the supporting frame 50 is fixed to the top plate circumferential outer edge 11a by tightening end portions 50a1, 50b1 of the division arms 50a, 50b together. Supporting pieces 50e, 50f are formed on the division arms 50a, 50b and the division arms 50a, 50b are attached to the top plate circumferential outer edge portion 11a of the drum 1 securely with the supporting pieces 50e, 50f keeping contact with the top plate 11.

The ultrasonic probe 2a is accommodated in an inner case 51 whose end is open and the inner case 51 is disposed movably within an outer case 52 whose end is open. A pair of connecting shafts 53 are provided symmetrically on the side portion of the outer case 52 and this pair of the connecting shafts 53 are connected to a supporting stay 55 fixed to the division arms 50a, 50b via each link 54. In this way, the outer case 52 is attached to the supporting frame 50 and a flange 52a is formed on the opening side of the outer case 52 and this flange 52a is provided with a plurality of sticking magnets 56 which sticks to a side plate 10 of the drum 1.

An adjust bolt 57 is bolted to the outer case 52 and a front end portion 57a of the adjust bolt 57 makes contact with an adjust plate 59 supported by the inner case 51 via a coil spring 58 which constitutes an urging means. A supporting pin 59a is fixed to the adjust plate 59 with a screw 59b and a coil spring 58 is supported by this supporting pin 59a. The inner case 51 is urged in a direction to the drum by this coil spring 58.

The position of the adjust plate 59 is adjusted by the adjust bolt 57 and the position of the inner case 51 is adjusted by change of the position of the adjust plate 59. The outer case 52 has an elongated hole 52b extending in a moving direction of the inner case 51 and a signal line 60 connected to the ultrasonic probe 2a goes through this elongated hole 52b, so that motion of the inner case 51 is not hampered by the signal line 60.

The outer case 52 attached to this supporting frame 50 is stuck to the side plate 10 of the drum 1 with the sticking magnet 56 and the coil spring 58 is provided between the outer case 52 and the inner case 51 so that the ultrasonic probe 2a is urged in a direction to the drum via the inner case 51 by this coil spring 58 and fitted to the side plate 10 of the drum 1 at a high accuracy.

By sticking this ultrasonic probe 2a to the side plate 10 of the drum 1 at a good accuracy, loss of the section such as corrosion, rust and abrasion due to physical factor generated in the inside face of the side plate 10 of the drum 1 can be inspected and detected securely and rapidly with ultrasonic wave generated by the ultrasonic probe 2a so as to specify its generation position.

Although in this embodiment, the supporting frame 50 is attached to the top plate circumferential outer edge portion 11a of the drum 1, it is permissible to invert the drum 1 to set its bottom plate upside and attach the supporting frame 50 to the bottom plate circumferential outer edge 12a and then attach a plurality of the ultrasonic probes 2a for generating ultrasonic wave for carrying out the primary inspection for the side plate 10. Although this embodiment utilizes eight pieces of the ultrasonic probes 2a, the number thereof is not limited to this as long as a plurality thereof are provided.

Next, the embodiment shown in FIG. 14 and FIG. 15 will be described. FIG. 14 is a plan view showing a condition in which the ultrasonic probes of the primary inspection ultrasonic wave device are attached to the drum. FIG. 15 is a side view showing a condition in which the ultrasonic probes of the primary ultrasonic wave device are attached to the drum.

Description of this embodiment is omitted while like reference numerals are attached to the same components as in FIG. 9 to 13. According to this embodiment, the detachable supporting frame 50 is attached to the top plate circumferential outer edge portion 11a of the drum 1 and ultrasonic wave is generated for the primary inspection of the top plate of the drum 1 with the plurality of the ultrasonic probes 2a attached to the supporting frame 50.

Although in this embodiment, the supporting frame 50 is attached to the top plate circumferential outer edge portion 11a of the drum 1, it is permissible to invert the drum 1 to set its bottom plate upside and attach the supporting frame 50 to the bottom plate circumferential outer edge portion 12a and then attach a plurality of the ultrasonic probes 2a for generating ultrasonic wave for the primary inspection of the bottom plate 12 to this supporting frame 50. Further, although eight pieces of the ultrasonic probes 2a are used in this embodiment, the number thereof is not restricted to this as long as the plurality thereof is provided.

Next, the embodiment shown in FIG. 16 will be described. FIG. 16 is a plan view showing a condition in which the ultrasonic probes of the primary inspection ultrasonic wave device are attached to the drum.

In this embodiment, description of the same structure as the embodiment shown in FIG. 9 to 15 is omitted while like reference numerals are attached. In this embodiment, the detachable supporting frame 50 is attached to the top plate circumferential outer edge portion 11a of the drum 1 and ultrasonic wave is generated for the primary inspection of the side plate of the drum 1 with a plurality of the ultrasonic probes 2a attached to this supporting frame 50 and then, ultrasonic wave is generated for the primary inspection of the top plate 11 of the drum 1 with a plurality of the ultrasonic probes 2a.

That is, the primary inspection of the side plate of the drum 1 is carried out by attaching eight pieces of the ultrasonic probes 2a to the supporting frame 50 and further, the primary inspection on the top plate 11 of the drum 1 is carried out by attaching eight pieces of the ultrasonic probes 2a.

Although in this embodiment, the supporting frame 50 is attached to the top plate circumferential outer edge portion 11a of the drum 1, it is permissible to invert the drum 1 to set its bottom plate 12 upside and attach the supporting frame 50 to the bottom plate circumferential outer edge portion 12a and then attach a plurality of the ultrasonic probes 2a for generating ultrasonic wave for the primary inspection of the side plate 10 and the primary inspection of the bottom plate 12. Further, although this embodiment utilizes 16 pieces of the ultrasonic probes 2a by attaching every eight pieces, the number thereof is not limited to this as long as a plurality thereof are provided.

### [Second Inspection]

Next, the second inspection will be described based on FIGS. 17 to 22. FIG. 17 is a diagram showing wave style of the longitudinal wave, FIG. 18 is a diagram showing a measuring principle, FIGS. 19 to 21 are a diagram showing a measurement result of simulated corrosion test and FIG. 22 is a diagram showing a Table on measurement result of a remaining thickness at an artificially created flaw portion by the simulated corrosion test.

In the second inspection, an extent of thickness reduction is detected by executing vertical flaw detection in a range obtained by the primary detection with the longitudinal ultrasonic wave using a second inspection ultrasonic device 20.

### (Second Inspection Ultrasonic Device)

The second inspection ultrasonic device 20 comprises an ultrasonic an ultrasonic probe 20a and an ultrasonic flaw detector 20b. The ultrasonic probe 20a uses longitudinal wave oscillators 20a1, 20a2 and this longitudinal oscillator 20a1 is an oscillator which oscillates by sliding corresponding to an excitation voltage so as to generate the lateral wave from the beginning. The longitudinal oscillator 20a2 is an oscillator which receives the longitudinal wave. The longitudinal wave oscillator 20a1 is widely used in generating ultrasonic wave. In the longitudinal oscillator 20a1, as shown in FIG. 17, the thickness increases or decreases corresponding to the excitation voltage. The longitudinal wave is a wave which expands or contracts in the propagation direction and does not expand or contract in a direction perpendicular to the propagation direction.

As shown in FIG. 18, the ultrasonic wave has a characteristic of being reflected if any defect exists during propagation. Ultrasonic plate thickness measurement of measuring the thickness of a sheet material using this characteristic is used and the longitudinal wave is used in this ultrasonic plate thickness measurement. The acoustic velocity of the ultrasonic wave is irrelevant to the frequency and determined depending on the kind of the ultrasonic wave and an object through which the ultrasonic wave is propagated. The acoustic velocity of the longitudinal wave is about twice the lateral wave.

In the ultrasonic wave plate thickness measurement, ultrasonic wave is transmitted from the longitudinal wave oscillator 20a1 and the same longitudinal wave oscillator 20a2. A two-oscillator type vertical probe in which transmission and receiving are separated is used to obtain a reflection from pitting corrosion having an extremely low reflectance. According to the principle of plate thickness measurement, when ultrasonic wave is entered into a smooth steel material whose front and rear surfaces are parallel from the front surface, the ultrasonic wave propagated through the steel reaches the rear surface and is reflected in the same way as light is reflected. When the ultrasonic wave is entered perpendicularly to the rear surface, it is reflected in an opposite direction to the incident direction and a time required for its reciprocation is found by receiving this. Because the acoustic velocity in substances is already known, a distance (plate thickness) from the probe to the rear surface can be found out.

### [Contact Medium]

The longitudinal wave transmitted from the longitudinal wave oscillator 20a1 can be entered into the steel material of the drum 1 easily through water, oil and glycerine. In the second inspection, it was confirmed that glycerine aqueous solution or equivalent or higher acoustic coupling was obtained.

### (Inspection Device)

As a ultrasonic flaw detector, a UI-23L pulse reflection type A-scope display function provided ultrasonic flaw detector manufactured by RYODEN SHONAN ELECTRONICS CORP. was used and as a ultrasonic probe 2a, a 10C5/2^{ND} two-oscillator type vertical probe manufactured by JAPAN PROBE CO., LTD. was used.

### (Inspection Method)

After the pitting corrosion was detected by the primary search so as to specify its generation place, ultrasonic plate thickness measurement was applied as a method for measure the remaining thickness at a pitting corrosion place as the secondary search. To see its effectiveness, it was confirmed whether it could measure the remaining thickness at the artificially created flaw portion of 0.4 mm, 0.8 mm and 1.2 mm with respect to φ5 mm, φ10 mm and φ20 mm and an error between a measured value and an actual remaining thickness was compared.

FIGS. 19 to 21 show a flaw detecting shape of an artificial flaw portion by the two-oscillator type vertical probe and FIG. 22 shows a remaining thickness measured value. The remaining thicknesses was 0.8 mm and 1.2 mm according to a measurement result with ultrasonic wave, which was 0.1 mm thicker than an actual remaining thickness. However, considering that the measurement accuracy of the ultrasonic flaw detector is ±0.1 mm, the measurement result exists within an acceptable error range and there is no problem in the measurement result. Because in the plate thickness measurement for the pitting corrosion, a reflection portion is a vertex portion of a sphere of the pitting corrosion, irregular reflection occurs much and reflection from the thinnest portion is hard to obtain and consequently, the plate thickness is indicated in a larger value than actual one.

### INDUSTRIAL APPLICABILITY

The present invention can be applied to the drum inspecting apparatus for inspecting a defect in the drum and can detect any defect in the section such as corrosion, rust and abrasion due to physical factor, generated in the inside face of the drum accommodating low level nuclear waste, securely and rapidly with a simple structure and specify its generation position.

### BRIEF DESCRIPTION OF THE DRAWINGS

FIG. 1 is a side view of a drum.

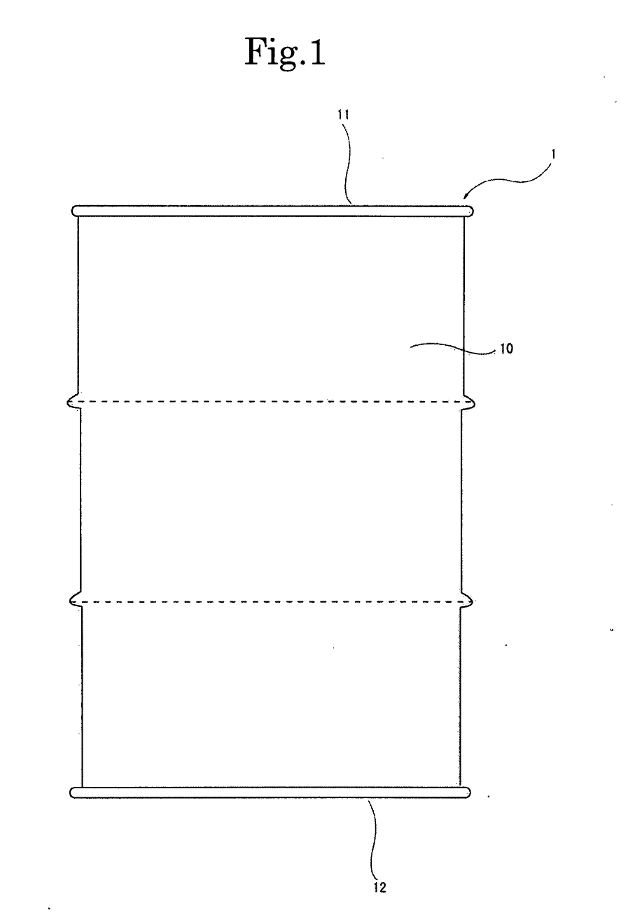

FIG. 2 is a sectional view of part of the drum.

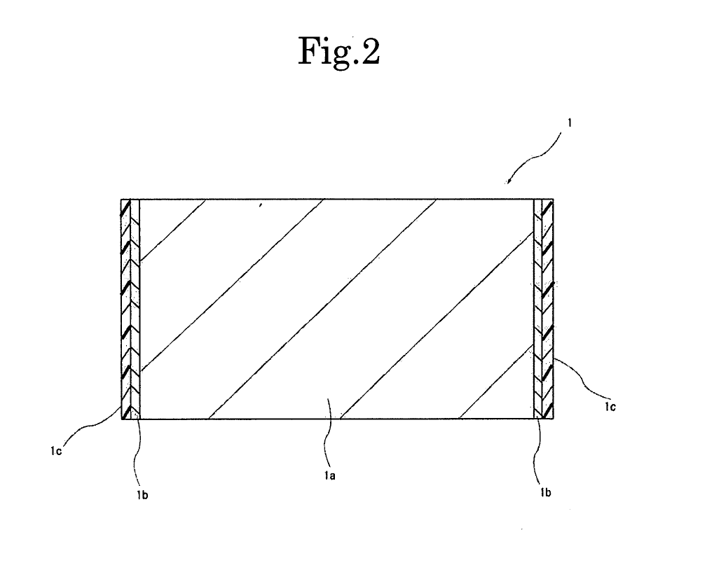

FIG. 3 is a diagram showing a wave style of SV wave.

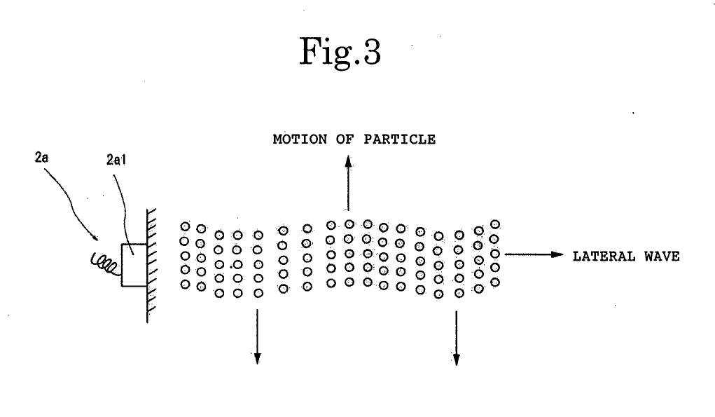

FIG. 4 is a diagram showing a wave style of SH wave.

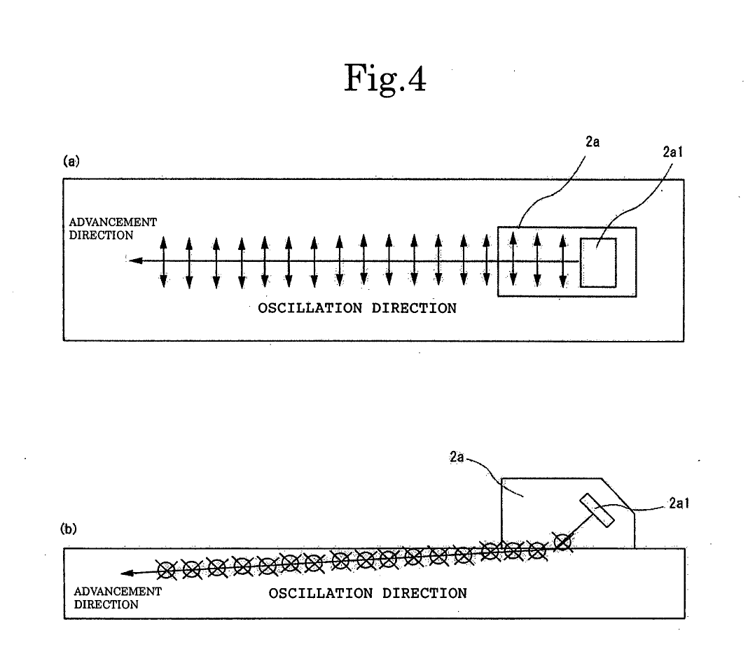

FIG. 5 is a diagram showing a condition of inspecting a drum from a top to a bottom.

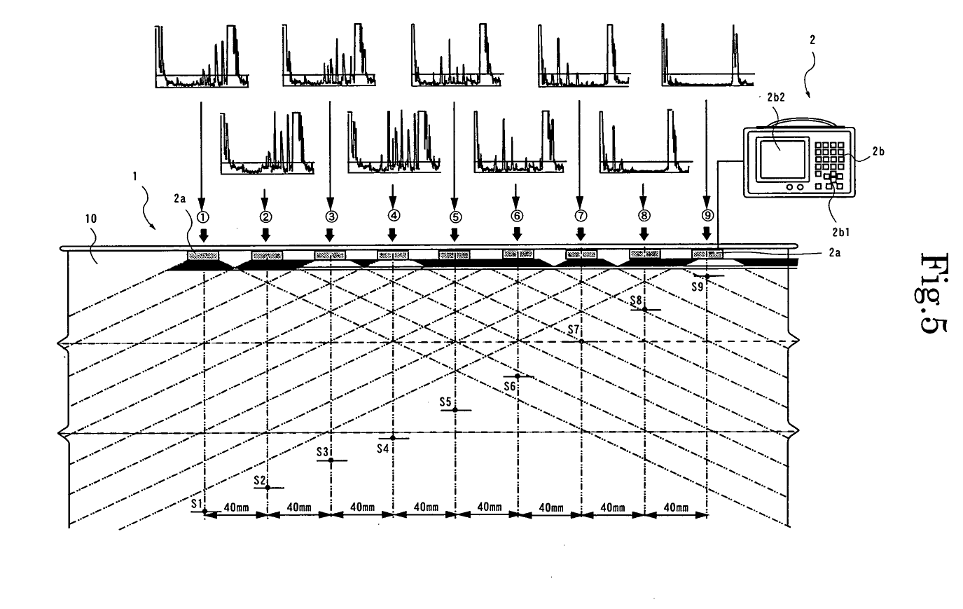

FIG. 6 is a diagram showing a condition of inspecting a drum from a bottom to a top.

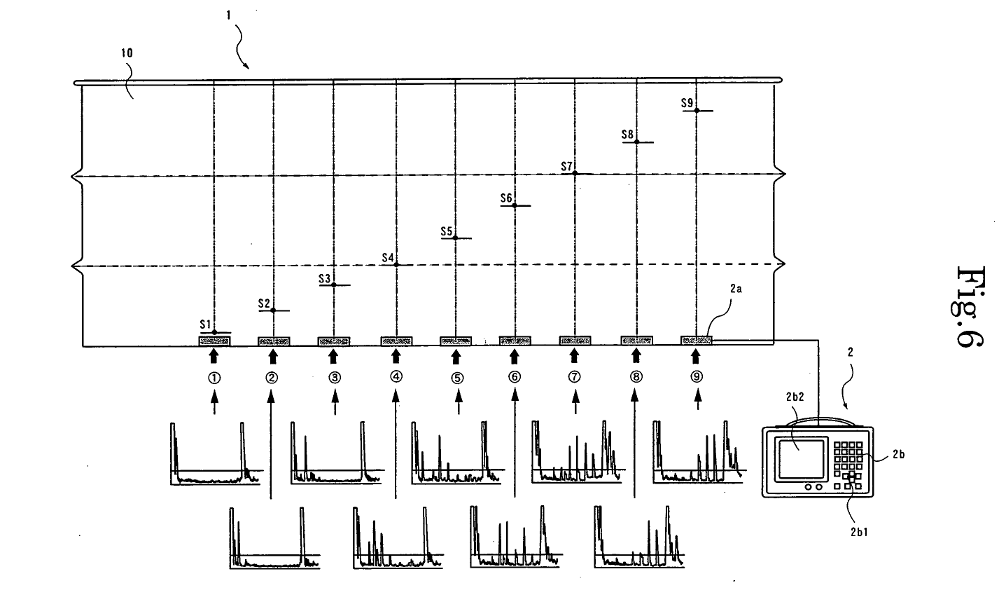

FIG. 7 is a diagram showing drill holes in the top plate and bottom plate.

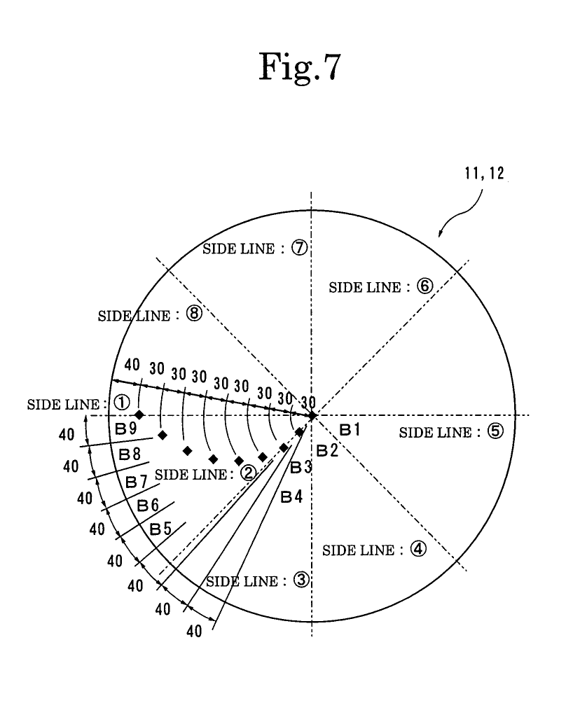

FIG. 8 is a diagram showing a condition of inspecting the top plate and bottom plate.

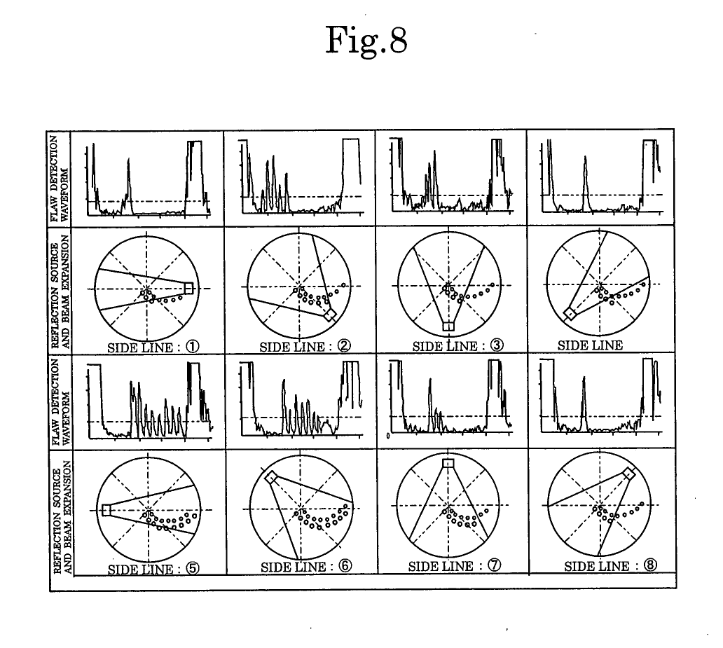

FIG. 9 is a plan view showing a condition in which the ultrasonic probes of the primary inspection ultrasonic wave device are attached to the drum.

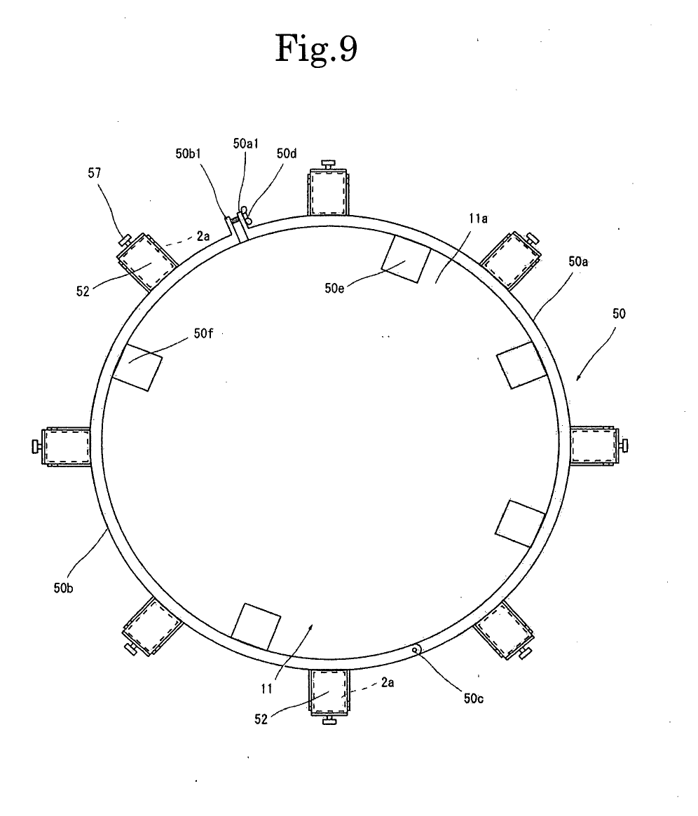

FIG. 10 is a side view showing a condition in which the ultrasonic probes of the primary inspection ultrasonic wave device are attached to the drum.

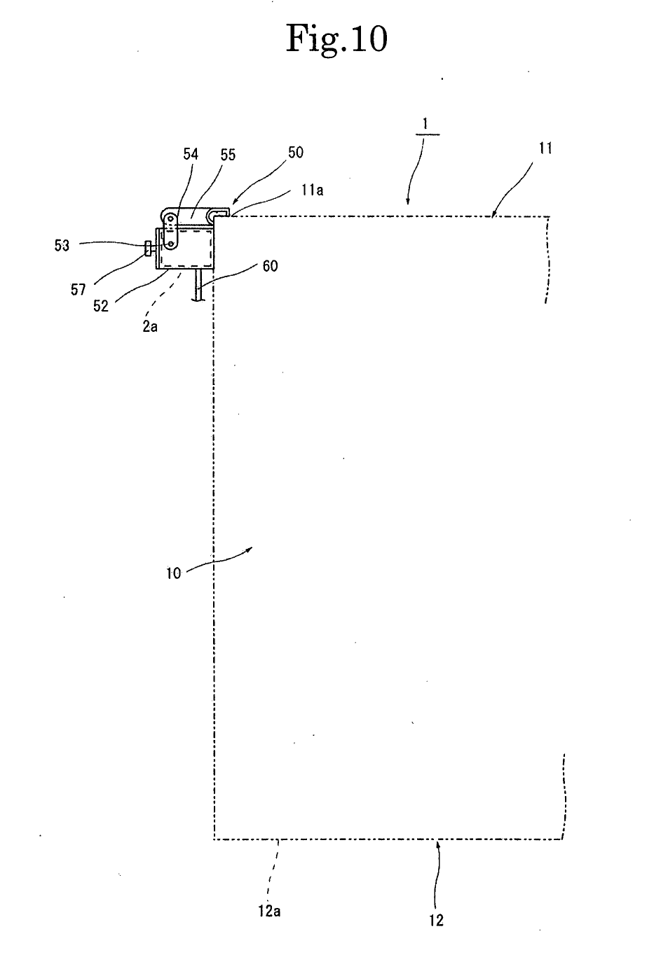

FIG. 11 is a plan view showing an attachment condition of the ultrasonic probes.

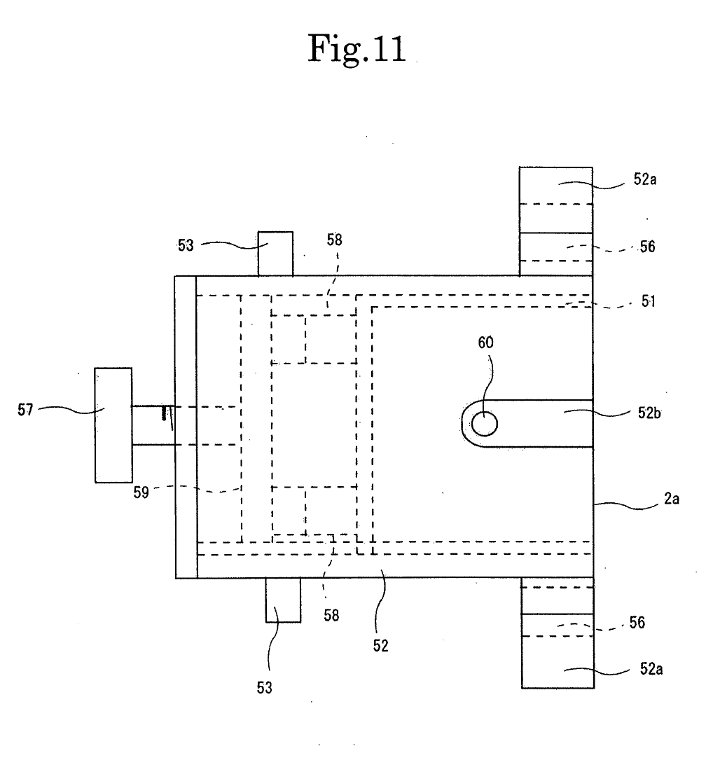

FIG. 12 is a side view showing the attachment condition of the ultrasonic probes.

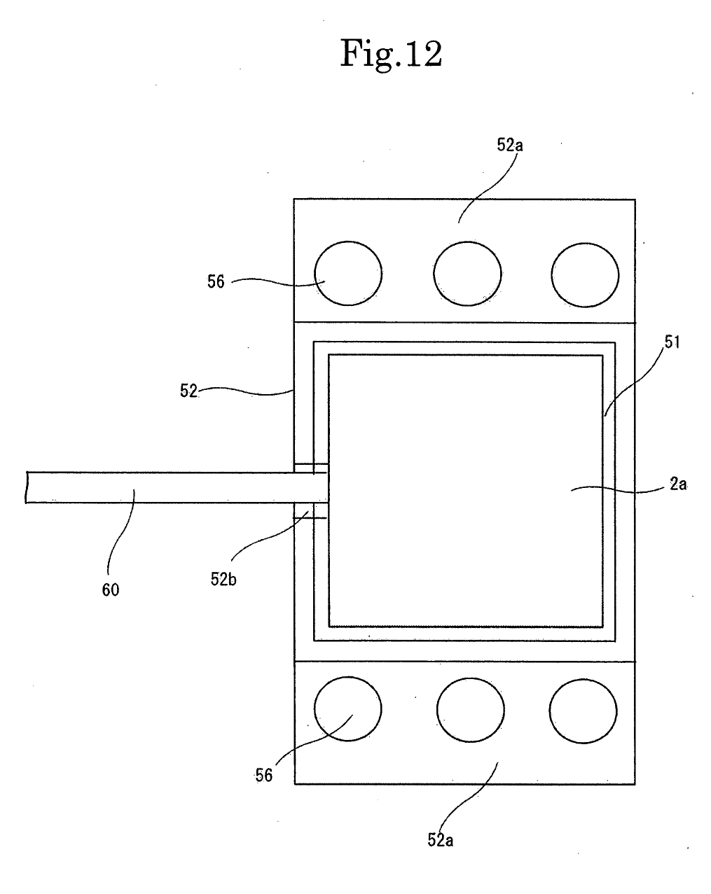

FIG. 13 is a sectional view showing the attachment condition of the ultrasonic probes.

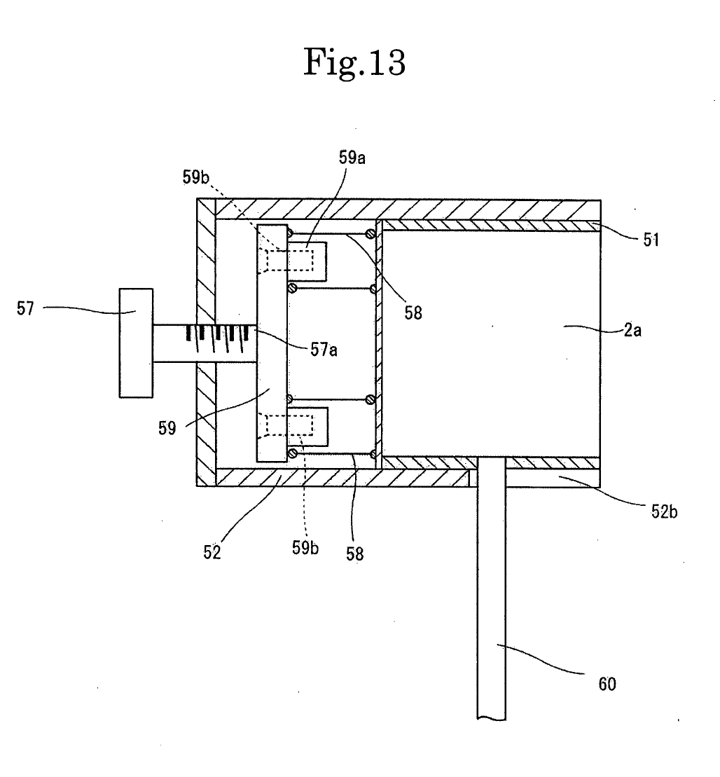

FIG. 14 is a plan view showing a condition in which the ultrasonic probes of the primary inspection ultrasonic wave device.

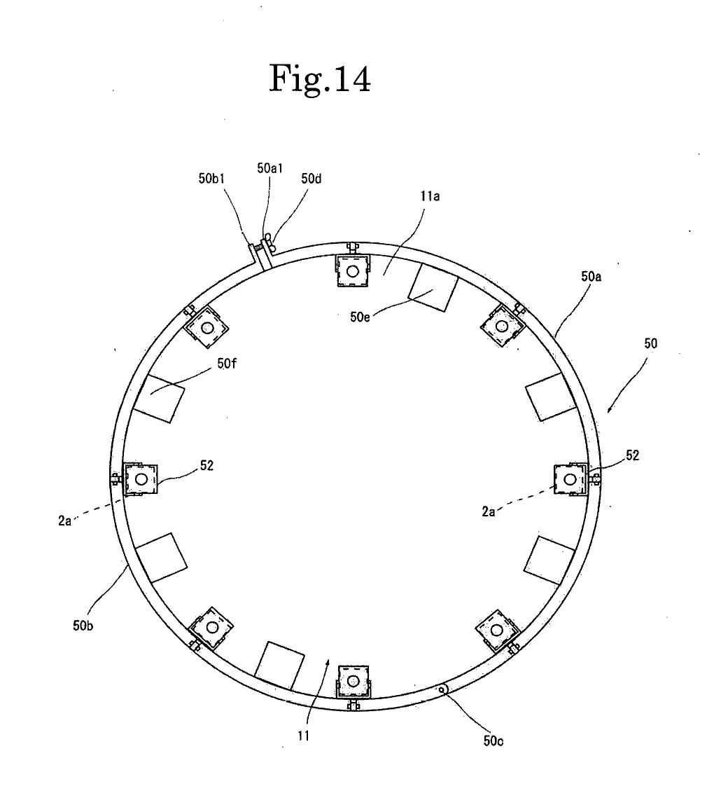

FIG. 15 is a side view showing a condition in which the ultrasonic probes of the primary inspection ultrasonic wave device.

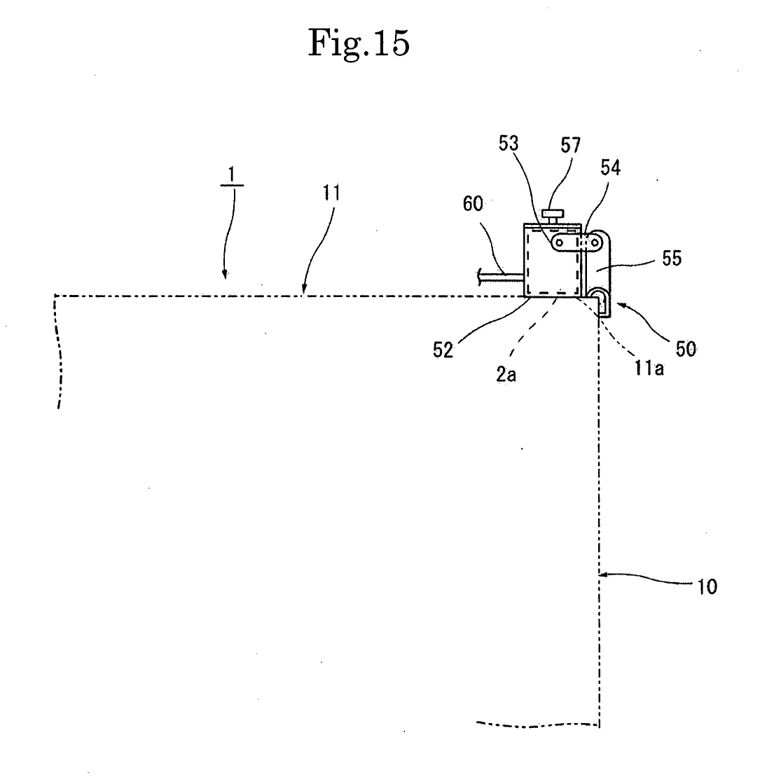

FIG. 16 is a plan view showing a condition in which the ultrasonic probes of the primary inspection ultrasonic wave device.

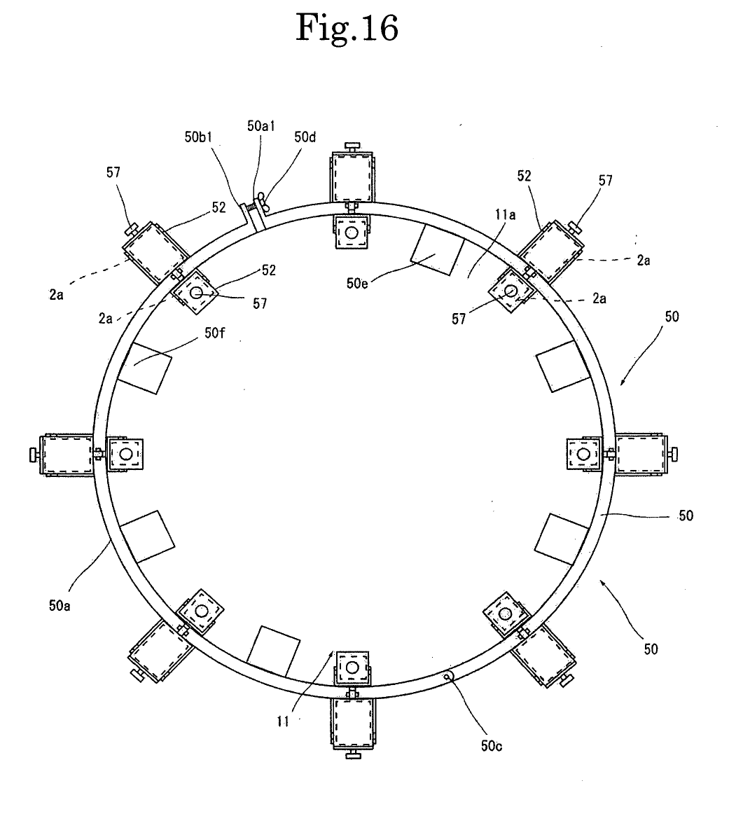

FIG. 17 is a diagram showing the wave style of the longitudinal wave.

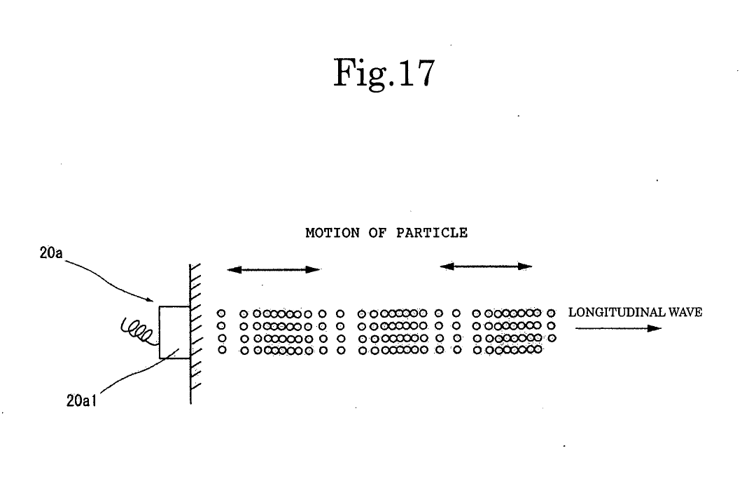

FIG. 18 is a diagram showing a measuring principle.

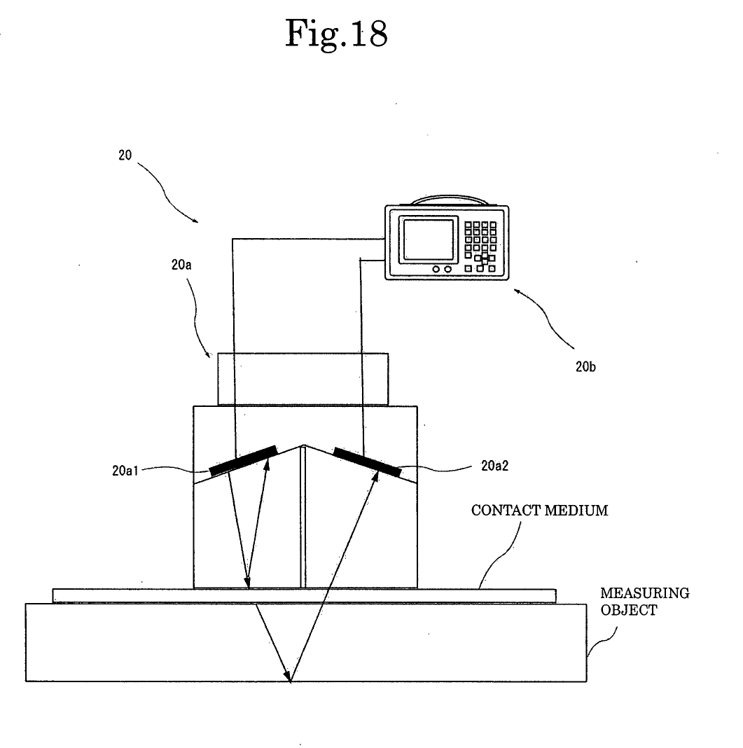

FIG. 19 is a diagram showing a measurement result of plate thickness by simulated corrosion test.

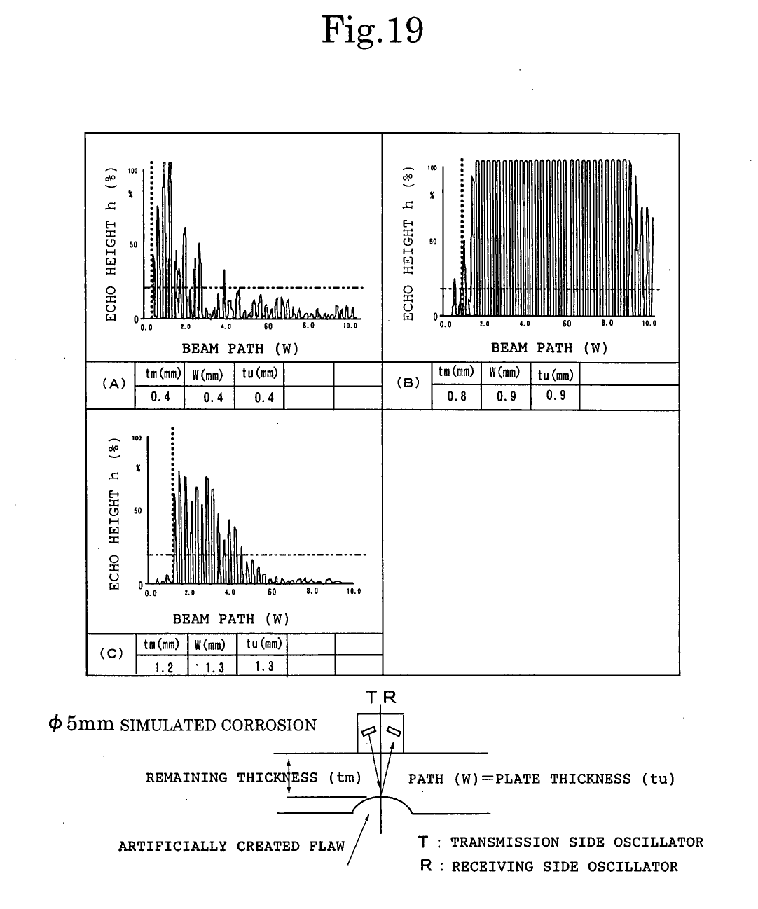

FIG. 20 is a diagram showing a measurement result of plate thickness by simulated corrosion test.

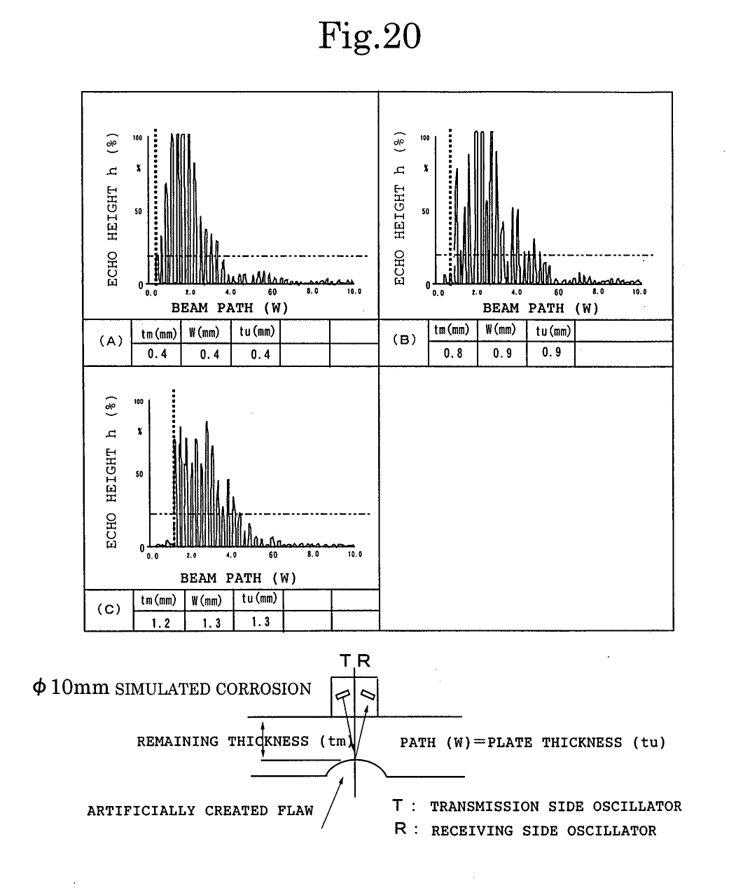

FIG. 21 is a diagram showing a measurement result of plate thickness by simulated corrosion test.

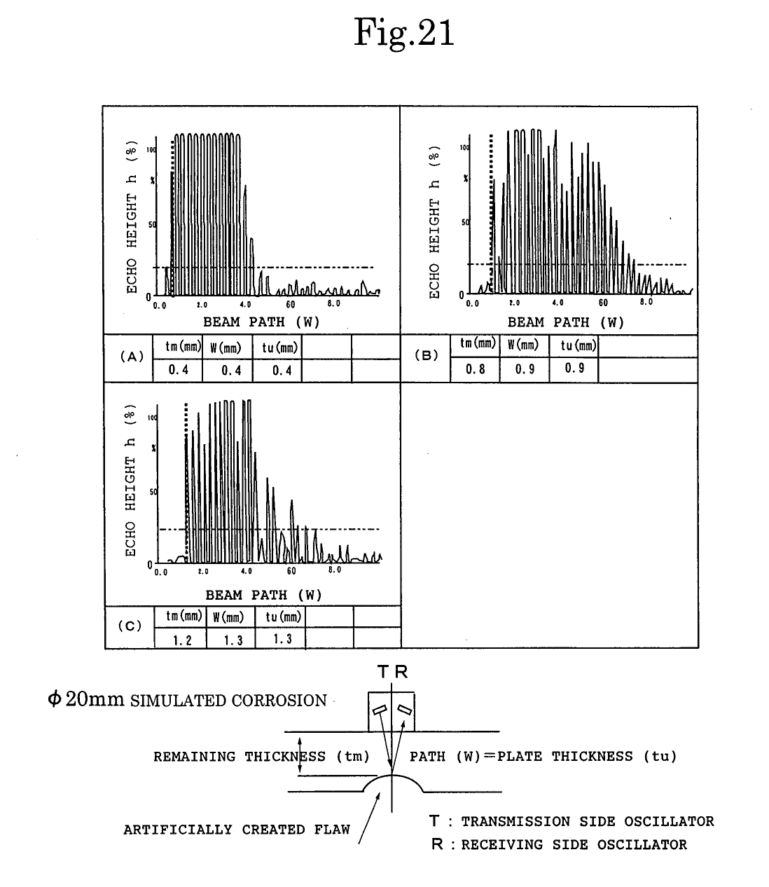

FIG. 22 is a diagram showing a Table on a measurement result of a remaining thickness at an artificially created flaw portion by the simulated corrosion test.

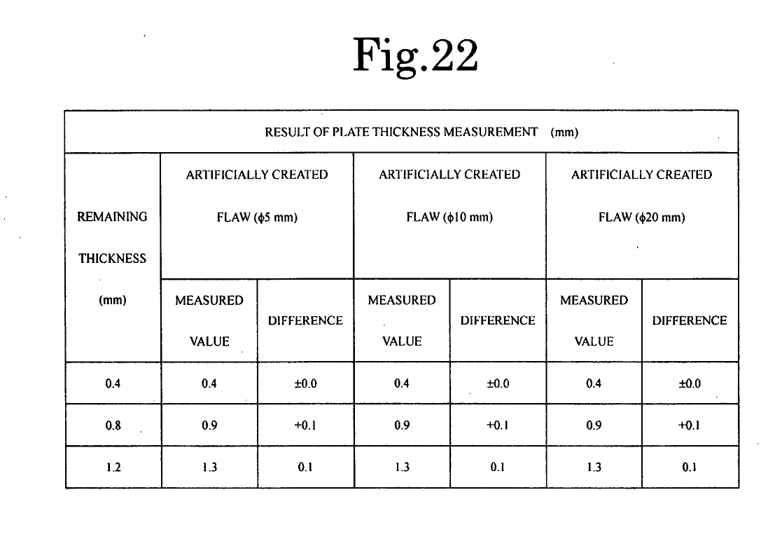

### REFERENCE NUMERAL

1: drum
1a: iron plate
1b: zinc plating
1c: resin film
2: first inspection ultrasonic device
2a: ultrasonic probe
2a1: lateral wave oscillator
2b: ultrasonic flaw detector
2b1: transmitting portion
2b2: receiving portion
10: side plate
11: top plate
12: bottom plate
20: second inspection ultrasonic device
20a: ultrasonic probe
20b: ultrasonic flaw detector
20a1, 20a2: longitudinal wave oscillator
S1-S9: drill hole
B1-B9: drill hole
50: supporting frame
50a, 50b: division arm
50c: supporting shaft
51: inner case
52: outer case
53: connecting shaft
54: link
55: supporting stay
56: sticking magnet
57: adjust bolt
58: coil spring
59: adjust plate

1. A drum inspecting apparatus for inspecting a loss in section generated in an inside face of a drum from an outer face side, comprising an inspection ultrasonic wave device for inspection by detecting a position having a reduced thickness generated in the inside face of the drum and estimating a range thereof with lateral ultrasonic wave, wherein
the inspection ultrasonic wave device has a plurality of ultrasonic probes for generating ultrasonic wave for the inspection of a side plate of the drum, attached to a top plate circumferential outer edge portion or a bottom plate circumferential outer edge portion of the drum.

2. A drum inspecting apparatus for inspecting a loss in section generated in an inside face of a drum from an outer face side, comprising an inspection ultrasonic wave device for inspection by detecting a position having a reduced thickness generated in the inside face of the drum and estimating a range thereof with lateral ultrasonic wave, wherein
the inspection ultrasonic wave device has a plurality of ultrasonic probes for generating ultrasonic wave for the inspection of a top plate or a bottom plate of the drum, attached to a top plate circumferential outer edge portion or a bottom plate circumferential outer edge portion of the drum.

3. A drum inspecting apparatus for inspecting a loss in section generated in the inside face of a drum accommodating low level nuclear waste from an outer face side, comprising an inspection ultrasonic wave device for inspection by detecting a position having a reduced thickness generated in the inside face of the drum and estimating a range thereof with lateral ultrasonic wave,
wherein the inspection ultrasonic wave device has
a plurality of ultrasonic probes for generating ultrasonic wave for the inspection of the side plate of the drum attached to the top plate circumferential outer edge portion or bottom plate circumferential outer edge portion of the drum, and
a plurality of ultrasonic probes for generating ultrasonic wave for the inspection of a top plate or a bottom plate of the drum attached to the top plate circumferential outer edge portion or bottom plate circumferential outer edge portion of the drum.

4. The drum inspecting apparatus according to claim 1, wherein a detachable supporting frame is attached to the top plate circumferential outer edge portion or the bottom plate circumferential outer edge portion and the supporting frame is provided with a plurality of ultrasonic probes for generating ultrasonic wave for the inspection of the side plate.

5. The drum inspecting apparatus according to claim 2, wherein a detachable supporting frame is attached to the top plate circumferential outer edge portion or the bottom plate circumferential outer edge portion and the supporting frame is provided with a plurality of ultrasonic probes for generating ultrasonic wave for the inspection of the top plate or the bottom plate.

6. The drum inspecting apparatus according to claim 1, wherein a detachable supporting frame is attached to the top plate circumferential outer edge portion or the bottom plate circumferential outer edge portion and the supporting frame is provided with a plurality of ultrasonic probes for generating ultrasonic wave for the inspection of the side plate and a plurality of ultrasonic probes for generating ultrasonic waves for the inspection of the top plate or the bottom plate.

7. The drum inspecting apparatus according to claim 1, wherein the ultrasonic probe is accommodated in an inner case an end of which is open, and the inner case is disposed movably within an outer case an end of which is open, the outer case being attached to the supporting frame and provided with a sticking magnet which is to be stuck to the drum, and an urging means for urging the ultrasonic probe in a direction to the drum being equipped between the outer case and the inner case.

8. The drum inspecting apparatus according to claim 1, wherein both faces of iron plate of the drum are galvanized and the galvanized surface is coated with resin film.

9. The drum inspecting apparatus according to claim 1, wherein the inspection is carried out by propagating the lateral ultrasonic wave from a top end portion to a bottom end portion of the side plate of the drum and from the bottom end portion to the top end portion.

10. The drum inspecting apparatus according to claim 1, wherein the inspection is carried out by propagating the lateral ultrasonic wave from the circumferential outer edge portion of the top plate or the bottom plate of the drum toward a central portion.
